(19) United States
(12) Patent Application Publication
(10) Pub. No.: US 2021/0313652 A1
(43) Pub. Date: Oct. 7, 2021

(54) GAS DIFFUSION LAYER, MEMBRANE ELECTRODE ASSEMBLY, AND FUEL BATTERY

(71) Applicant: Panasonic Intellectual Property Management Co., Ltd., Osaka (JP)

(72) Inventors: TSUTOMU KAWASHIMA, Nara (JP); MIYUKI YOSHIMOTO, Osaka (JP); TAKESHI MINAMIURA, Osaka (JP); SHINICHIRO IMURA, Hyogo (JP)

(21) Appl. No.: 17/207,794

(22) Filed: Mar. 22, 2021

(30) Foreign Application Priority Data
Apr. 7, 2020 (JP) 2020-068847

(51) Int. Cl. H01M 50/446; H01M 8/1004

(52) U.S. Cl. CPC H01M 50/446; H01M 8/1004

(57) ABSTRACT

A gas diffusion layer includes conductive particles, conductive fibers, and polymer resins, in which an amount of surface functional groups in the conductive particle is 0.25 mmol/g or less.

### BACKGROUND

### 1. Technical Field

The present disclosure relates to a gas diffusion layer, a membrane electrode assembly, and a fuel battery.

### 2. Description of the Related Art

A gas diffusion layer has gas permeability and a gas diffusion property, and is used for, for example, a fuel battery. In a polymer electrolyte fuel battery, which is an example of a fuel battery, one side of a hydrogen ion conductive polymer electrolyte membrane is exposed to a fuel gas such as hydrogen, and the other side is exposed to oxygen, and water is thus synthesized by a chemical reaction via the electrolyte membrane. As a result, reaction energy generated when synthesizing is electrically extracted.

A single cell of the polymer electrolyte fuel battery has a membrane electrode assembly (hereinafter referred to as “MEA”) and a pair of conductive separators disposed on both sides of the MEA. The MEA includes a hydrogen ion conductive polymer electrolyte membrane and a pair of electrode layers with the electrolyte membrane interposed therebetween. The pair of electrode layers have a catalyst layer formed on both sides of the polymer electrolyte membrane and containing carbon powders supporting a platinum group catalyst as a main component, and a gas diffusion layer formed on the catalyst layer and having a collecting action together with gas permeability and water repellency.

The gas diffusion layer in the MEA uniformly supplies a gas supplied from the separator to the catalyst layer. In addition, the gas diffusion layer functions as a conductive path for electrons between the catalyst layer and the separator. Therefore, a conductive porous member may be used for the gas diffusion layer used in the MEA.

Further, high water repellency is required for the gas diffusion layer in the MEA so that excess moisture produced in the catalyst layer by the fuel battery reaction is quickly removed and discharged outside the MEA system, and pores of the gas diffusion layer are not blocked by the produced water. Therefore, a gas diffusion layer having a conductive porous member is subjected to a water repellent treatment with a fluororesin or the like and a water repellent layer provided on a side being in contact with a catalyst layer of a conductive substrate and containing a water repellent resin such as carbon powders and a fluororesin as a main component, is generally used.

In this way, by subjecting the conductive substrate to the water repellent treatment, the pores of the gas diffusion layer are prevented from being blocked by the produced water. Further, by making the water repellent layer have a higher water repellency than the conductive substrate, excess moisture produced in the catalyst layer is quickly discharged outside the MEA system.

For example, Japanese Patent No. 4938133 discloses a gas diffusion layer having a porous structure containing conductive particles and a polymer resin as main components and a carbon fiber having a weight smaller than a weight of a polymer resin.

### SUMMARY

According to a first aspect of the present disclosure, a gas diffusion layer includes conductive particles, conductive fibers, and polymer resins, in which an amount of surface functional groups in each of the conductive particles is 0.25 mmol/g or less.

According to a second aspect of the present disclosure, a gas diffusion layer includes conductive particles, conductive fibers, and polymer resins, in which a total amount of acidic functional groups in each of the conductive particles is 0.15 mmol/g or less.

According to a third aspect of the present disclosure, a gas diffusion layer includes conductive particles, conductive fibers, and polymer resins, in which an amount of basic functional groups in each of the conductive particles is 0.10 mmol/g or less.

### BRIEF DESCRIPTION OF THE DRAWINGS

FIG. 1 is a schematic view showing a configuration of a polymer electrolyte fuel battery stack according to a first exemplary embodiment of the present disclosure;

FIG. 2 is a schematic cross-sectional view showing a configuration of a polymer electrolyte fuel battery cell according to the first exemplary embodiment of the present disclosure;

FIG. 3A is a schematic view of a gas diffusion layer according to the first exemplary embodiment of the present disclosure;

FIG. 3B is an enlarged schematic view of a part of the gas diffusion layer according to the first exemplary embodiment of the present disclosure;

FIG. 4 is a flowchart showing a method of manufacturing a gas diffusion layer according to the first exemplary embodiment of the present disclosure;

FIG. 5 is Table 1 showing measurement results of an amount of functional groups in a conductive particle and an amount of functional groups in a conductive fiber used as the materials of Examples and Comparative Examples; and

FIG. 6 is Table 2 showing results of an evaluation test performed on Examples 1 to 6 and Comparative Examples 1 and 2.

### DETAILED DESCRIPTIONS

In the gas diffusion layer described in Japanese Patent No. 4938133, water repellency of the gas diffusion layer cannot be sufficiently enhanced, and there is a possibility that excess moisture cannot be discharged quickly.

An object of the present disclosure is to provide a gas diffusion layer, a membrane electrode assembly, and a fuel battery having sufficient gas permeability and excellent a discharging property of excess moisture.

According to a first aspect, a gas diffusion layer includes a conductive particle, a conductive fiber, and a polymer resin, in which an amount of surface functional groups in the conductive particle is 0.25 mmol/g or less.

According to a second aspect, a gas diffusion layer includes conductive particles, conductive fibers, and polymer resins, in which a total amount of acidic functional groups in the conductive particle is 0.15 mmol/g or less.

According to a third aspect, a gas diffusion layer includes conductive particles, conductive fibers, and polymer resins, in which an amount of basic functional groups in the conductive particle is 0.10 mmol/g or less.

In the gas diffusion layer according to a fourth aspect, according to any one of the first to third aspects, an amount of surface functional groups in the conductive fiber may be 0.3 mmol/g or less.

In the gas diffusion layer according to a fifth aspect, according to any one of the first to third aspects, a total amount of acidic functional groups in the conductive fiber may be 0.15 mmol/g or less.

In the gas diffusion layer according to a sixth aspect, according to any one of the first to third aspects, an amount of basic functional groups in the conductive fiber may be 0.10 mmol/g or less.

In the gas diffusion layer according to a seventh aspect, according to any one of the first to sixth aspects, an amount of the conductive fibers in the gas diffusion layer may be larger than an amount of the conductive particles in the gas diffusion layer.

In the gas diffusion layer according to an eighth aspect, according to any one of the first to seventh aspects, the conductive particle may include carbon black having a BET specific surface area of 100 m²/g or less.

In the gas diffusion layer according to a ninth aspect, according to any one of the first to eighth aspects, the conductive fiber may include a carbon nanotube having a fiber diameter of 50 nm or more and 300 nm or less and a fiber length of 0.5 μm or more and 50 μm or less.

In the gas diffusion layer according to a tenth aspect, according to any one of the first to ninth aspects, the polymer resin may include polytetrafluoroethylene.

In the gas diffusion layer according to an eleventh aspect, according to any one of the first to tenth aspects, the gas diffusion layer may include the conductive particles of 5 wt % or more and less than 35 wt %.

In the gas diffusion layer according to a twelfth aspect, according to any one of the first to third aspects, the gas diffusion layer may include the conductive fibers of 35 wt % or more and 80 wt % or less.

In the gas diffusion layer according to a thirteenth aspect, according to any one of the first to third aspects, the gas diffusion layer may include the polymer resins of 10 wt % or more and 40 wt % or less.

In the gas diffusion layer according to a fourteenth aspect, according to any one of the first to thirteenth aspects, the conductive particles, the conductive fibers, and the polymer resins may constitute a porous structure, a cumulative pore volume of the porous structure may be 1.3 mL/g or more and 1.7 mL/g or less, and a peak of a pore diameter distribution of the porous structure may be in a range of 0.1 μm or more and 0.3 μm or less.

In the gas diffusion layer according to a fifteenth aspect, according to any one of the first to fourteenth aspects, a tensile break strength of the gas diffusion layer may be 0.05 N/mm² or more.

In the gas diffusion layer according to a sixteenth aspect, according to any one of the first to fifteenth aspects, the gas diffusion layer may be a self-supporting membrane supported by the conductive particles, the conductive fibers, and the polymer resins.

According to a seventeenth aspect, a membrane electrode assembly includes the gas diffusion layer according to any one of the first to sixteenth aspects, a pair of electrodes, and an electrolyte membrane.

According to an eighteenth aspect, a fuel battery includes the gas diffusion layer according to any one of the first to sixteenth aspects, and a current collecting plate.

The present disclosure can provide a gas diffusion layer for a fuel battery, a membrane electrode assembly, and a fuel battery having sufficient gas permeability and a water discharging property while keeping the water contained inside the MEA.

Hereinafter, a gas diffusion layer, a membrane electrode assembly, and a fuel battery according to an exemplary embodiment of the present disclosure will be described with reference to the drawings. Substantially same members are given the same reference numerals in the drawings.

### First Exemplary Embodiment

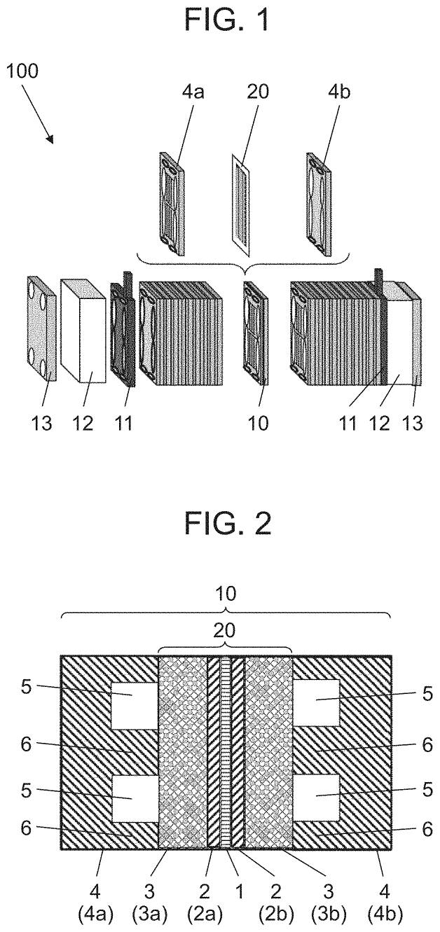

The basic configuration of fuel battery 100 according to a first exemplary embodiment of the present disclosure will be described with reference to FIG. 1. FIG. 1 is a schematic view showing a configuration of fuel battery (hereinafter, referred to as “polymer electrolyte fuel battery stack”) 100 according to the first exemplary embodiment. The first exemplary embodiment is not limited to the polymer electrolyte fuel battery, but can be applied to various fuel batteries.

### Fuel Battery

As shown in FIG. 1, fuel battery 100 is formed by stacking one or more battery cells 10, which are basic units, and compressing and fastening battery cells 10 with a predetermined load using current collecting plates 11, insulating plates 12, and end plates 13 each of which is disposed on both sides of stacked battery cell 10.

Current collecting plate 11 is formed of a conductive material with gas impermeability. For example, copper, brass, or the like is used for current collecting plate 11. Current collecting plate 11 is provided with a current extraction terminal portion (not shown), and a current is extracted from the current extraction terminal portion during power generation.

Insulating plate 12 is formed of an insulating material such as a resin. For example, a fluororesin, a PPS resin, or the like is used for insulating plate 12.

End plate 13 fastens and holds one or more stacked battery cells 10, current collecting plate 11, and insulating plate 12 with a predetermined load by a pressurizing unit (not shown). For example, a metal material with high rigidity such as steel is used for end plate 13.

### Battery Cell

FIG. 2 is a schematic cross-sectional view showing a configuration of battery cell 10 according to the first exemplary embodiment. In the battery cell 10, membrane electrode assembly (hereinafter, referred to as MEA) 20 is interposed between anode-side separator 4a and cathode-side separator 4b. In the following, anode-side separator 4a and cathode-side separator 4b are collectively referred to as separator 4. The same description will be made for other components when a plurality of components are described together.

Fluid flow passage 5 is formed in separator 4. Fluid flow passage 5 for a fuel gas is formed in anode-side separator 4a. Fluid flow passage 5 for an oxidizer gas is formed in cathode-side separator 4b. A carbon-based material or a metal-based material is used for separator 4.

Fluid flow passage 5 is a groove formed in separator 4. Rib portions 6 are provided around fluid flow passage 5.

### Membrane Electrode Assembly: MEA

Membrane electrode assembly (MEA) 20 has polymer electrolyte membrane 1, catalyst layer 2, and gas diffusion layer 3. Anode catalyst layer 2a and cathode catalyst layer 2b (collectively referred to as catalyst layer 2) are formed on both sides of polymer electrolyte membrane 1 selectively transporting hydrogen ions, and anode-side gas diffusion layer 3a and cathode gas diffusion layer 3b (collectively referred to as gas diffusion layer 3) are disposed on outer sides of anode catalyst layer 2a and cathode catalyst layer 2b, respectively.

For example, a perfluorocarbon sulfonic acid polymer is used for polymer electrolyte membrane 1, but polymer electrolyte membrane 1 is not particularly limited as long as it has proton conductivity.

As catalyst layer 2, a layer containing a carbon material supporting catalyst particles such as platinum and a polymer electrolyte can be used.

### Gas Diffusion Layer

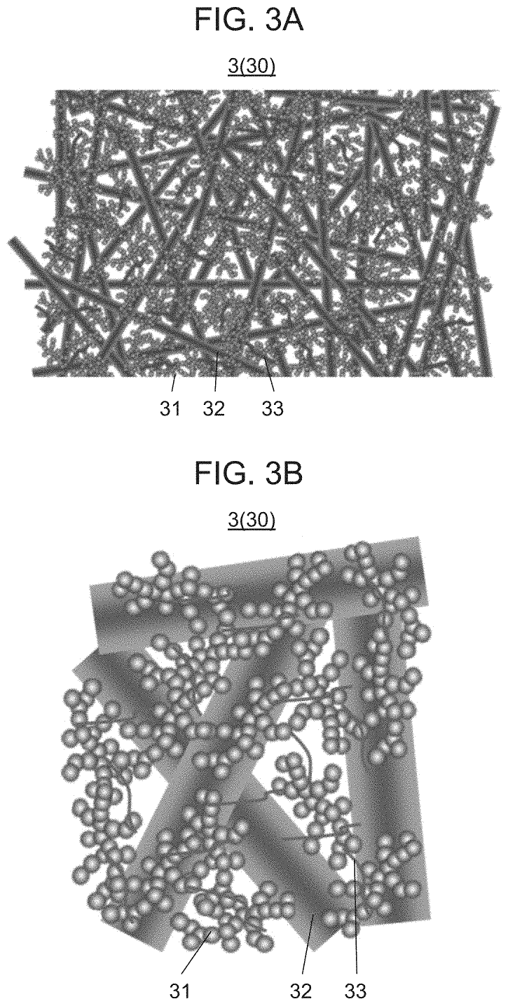

Next, a configuration of gas diffusion layer 3 according to the first exemplary embodiment of the present disclosure will be described in detail with reference to FIGS. 3A and 3B.

FIG. 3A is a schematic view of porous structure 30 constituting gas diffusion layer 3. FIG. 3B is an enlarged schematic view of a part of porous structure 30 constituting gas diffusion layer 3. Porous structure 30 contains conductive particles 31, conductive fibers 32, and polymer resins 33. That is, gas diffusion layer 3 contains conductive particles 31, conductive fibers 32, and polymer resins 33. In the first exemplary embodiment, as shown in FIG. 3A, gas diffusion layer 3 is composed of porous structure 30. Gas diffusion layer 3 may be a self-supporting membrane supported by conductive particles 31, conductive fibers 32, and polymer resins 33. The self-supporting membrane means a membrane having a self-supporting structure.

### Conductive Particles

Conductive particles 31 of the present disclosure satisfy any of the following conditions.

(1) An amount of surface functional groups in conductive particle 31 is 0.25 mmol/g or less.

(2) A total amount of acidic functional groups in conductive particle 31 is 0.15 mmol/g or less.

(3) An amount of basic functional groups in conductive particle 31 is 0.10 mmol/g or less.

Conductive particles 31 may satisfy any one of conditions (1) to (3). From the viewpoint of enhancing a gas diffusion property and a water discharging property of gas diffusion layer 3, conductive particles 31 may satisfy any two or all of conditions (1) to (3).

When conductive particles 31 satisfy any of conditions (1) to (3), that is, the amount of functional groups in conductive particle 31 is equal to or less than a certain amount, gas diffusion layer 3 has a sufficient gas diffusion property and an excellent discharging property of excess moisture. The reason for this is considered as follows. For example, in the fuel battery, protons move from an anode side to a cathode side through the polymer electrolyte membrane during power generation. The protons move with entrained water when moving. Therefore, the water on the anode side moves to the cathode side together with the protons. Accordingly, a produced water produced by power generation reaction and the entrained water are present on the cathode side, and amounts of the produced water and the entrained water thus increase as the cathode side becomes a high current density region. Some of the water on the cathode side is discharged to the outside through pores of the gas diffusion layer on the cathode side, and some of the other water is back-diffused to the anode side due to a difference in concentration through the polymer electrolyte membrane. In the high current density region, the gas diffusion property can be secured while keeping the water contained in the polymer electrolyte membrane, thereby enhancing battery performance.

However, when the water is contained inside membrane electrode assembly 20, a gas diffusion path of the gas diffusion layer or the catalyst layer on the cathode side may be blocked by the water. In gas diffusion layer 3 of the present disclosure, conductive particles 31 having a certain amount or less of the functional groups are used. Therefore, when gas diffusion layer 3 of the present disclosure is used as a gas diffusion layer on the cathode side, the produced water and the entrained water on the cathode side can be retained and back-diffused to the anode side, and excessive water can be discharged to the outside through gas diffusion layer 3, and thus the gas diffusion path is hardly blocked. Therefore, proton resistance of the high current density region can be reduced while keeping the water contained inside MEA 20 proper, and the gas diffusion path can be prevented from blocking by the excess moisture.

A mechanism to obtain such an effect by setting the amount of the functional groups to a certain amount or less is not understood correctly, but a reason for this is presumed as follows. The excess moisture inside MEA 20 is discharged to the outside through the pores in the porous structure of gas diffusion layer 3. At this time, moisture such as water or water vapor passes through the pores in the porous structure of gas diffusion layer 3. When the functional groups in conductive particle 31 are present in the pores of gas diffusion layer 3, the functional groups suck water molecules by hydrogen bonding, and clusters are thus easily formed. The cluster serves as a suction site, which proceeds to suck water into the pores to produce condensed water in the pores and suppress the diffusion of gas. However, when the amount of functional groups in conductive particle 31 is equal to or less than a certain amount, it is considered that it is possible to suppress the formation of the clusters which are the suction sites and enhance a moisture discharging property.

Conductive particles 31 are not particularly limited as long as they satisfy any of conditions (1) to (3) described above. Examples of conductive particle 31 can include carbon black FX-80 or FX-100 produced by Cabot Corporation, DENKA BLACK HS-100, granular DENKA BLACK, powdered DENKA BLACK produced by Denka Company Limited.

The amount of surface functional groups, the total amount of acidic functional groups, and the amount of basic functional groups are measured by an acid-base titration method (Boehm method). A specific method of the Boehm method can be referred to Boehm, H. P., Advances in Catalysis, 16, 179 (1966). An alkaline aqueous solution of sodium hydroxide is added to a sample of conductive particle 31 and stirred under a nitrogen atmosphere. The sample is allowed to stand at room temperature and precipitated, thereby performing back titration on a filtered filtrate by hydrochloric acid. Consumption of the hydrochloric acid at this time can be used as the amount of basic functional groups in conductive particle 31. Further, an acidic aqueous solution of hydrochloric acid is added to a sample of conductive particle 31 and stirred under a nitrogen atmosphere. The sample is allowed to stand at room temperature and precipitated, thereby performing back titration on a filtered filtrate by sodium hydroxide. Consumption of the sodium hydroxide at this time can be used as the total amount of acidic functional groups in conductive particle 31. The amount of surface functional groups can be a value obtained by adding the total amount of acidic functional groups and the amount of basic functional groups.

Conductive particle 31 may include carbon black having a BET specific surface area of 100 m²/g or less. In this case, a positive correlation is generally seen between the BET specific surface area and the amount of functional groups. That is, the smaller the BET specific surface area, the smaller the amount of functional groups. Specifically, when the BET specific surface area is 100 m²/g or less, the amount of functional groups in conductive particle 31 can easily satisfy conditions (1) to (3) described above. Therefore, gas diffusion layer 3 has an excellent gas diffusion property and a discharging property of excess moisture when the BET specific surface area of conductive particle 31 is 100 m²/g or less.

### Conductive Fiber

Conductive fibers 32 contribute to improvement in conductivity and a mechanical strength of gas diffusion layer 3. A material of conductive fiber 32 is not particularly limited, but examples thereof can include carbon fibers such as carbon nanotubes.

Conductive fibers 32 of the present disclosure satisfy any of the following conditions.

(4) An amount of surface functional groups in conductive fiber 32 is 0.3 mmol/g or less.

(5) A total amount of acidic functional groups in conductive fiber 32 is 0.15 mmol/g or less.

(6) An amount of basic functional groups in conductive fiber 32 is 0.10 mmol/g or less.

The conductive fibers 32 may satisfy any one of the conditions (4) to (6). From the viewpoint of enhancing the gas diffusion property and the water discharging property of gas diffusion layer 3, conductive fibers 32 may satisfy any two of conditions (4) to (6). Further, conductive fibers 32 may satisfy all of conditions (4) to (6).

When the amount of functional groups in conductive fiber 32 in gas diffusion layer 3 is a certain amount or less, the functional groups suck water molecules, and clusters which are suction sites are less likely to be formed. Therefore, the suction of water in the pores is hardly to proceed, so that it is possible to suppress the production of condensed water in the pores, and the gas diffusion in gas diffusion layer 3 is less likely to be suppressed. As a result, the moisture discharging property of gas diffusion layer 3 can be enhanced.

An average fiber diameter of conductive fiber 32 may be 50 nm or more and 300 nm or less. When the average fiber diameter of conductive fiber 32 is 50 nm or more, it contributes more effectively to the improvement in the conductivity of gas diffusion layer 3, and the mechanical strength of gas diffusion layer 3 can be further enhanced, and thus gas diffusion layer 3 has a sufficient strength as a self-supporting membrane. Further, when the average fiber diameter of the conductive fiber 32 is 300 nm or less, it is easy to sufficiently secure a pore volume of porous structure 30 because the diameter is not too large, and the gas diffusion property of gas diffusion layer 3 can be more enhanced.

An average fiber length of conductive fiber 32 may be 0.5 μm or more and 50 μm or less. When the average fiber length of conductive fiber 32 is 0.5 μm or more, it contributes more effectively to the improvement in the conductivity of gas diffusion layer 3, and the mechanical strength of gas diffusion layer 3 can be further enhanced. Further, when the average fiber length of the conductive fiber 32 is 50 μm or less, it is easy to sufficiently secure the pore volume of porous structure 30 because the fiber is not too long, a water repellency of gas diffusion layer 3 can be more enhanced. As a result, the gas diffusion property of gas diffusion layer 3 can be enhanced.

### Polymer Resin

Examples of a material of polymer resin 33 can include polytetrafluoroethylene (PTFE), tetrafluoroethylene-hexafluoropropylene copolymer (FEP), polyvinylidene fluoride (PVDF), tetrafluoroethylene-ethylene copolymer (ETFE), polychlorotrifluoroethylene (PCTFE), and polyfluoroethylene-perfluoroalkyl vinyl ether copolymer (PFA). In particular, from the viewpoint of heat resistance, water repellency, and chemical resistance, polymer resin 33 may contain PTFE. Examples of a raw material form of PTFE can include a dispersion form or a powdered form, and the dispersion form may be used from the viewpoint of having excellent dispersibility.

Polymer resin 33 functions as a binder that binds conductive particles 31 to each other. Further, polymer resin 33 has water repellency. As a result, it is possible to suppress that water stays in the pores inside gas diffusion layer 3 and gas permeation is hindered.

### Contents of Conductive Fibers, Conductive Particles, and Polymer Resins in Gas Diffusion Layer

An amount of conductive fibers 32 in gas diffusion layer 3 may be larger than an amount of conductive particles 31 in gas diffusion layer 3. A pore in an order of 0.1 μm is easily formed by a gap between conductive fibers 32, and a pore having a diameter of several tens of nm is easily formed by a gap between primary particles of conductive particles 31. Therefore, since an amount of conductive fibers 32 is larger than an amount of conductive particles 31, a peak of a pore diameter in gas diffusion layer 3 is likely to be in a range of 0.1 μm or more and 0.3 μm or less. When the peak of the pore diameter is in this range, water vapor permeability of gas diffusion layer 3 can be sufficiently secured, while gas diffusion layer 3 has low permeability to micro mist. Therefore, excess moisture can be quickly discharged as water vapor while keeping water contained inside MEA 20 proper. Further, in gas diffusion layer 3, that is, in porous structure 30, conductive particles 31 are present in the gap between conductive fibers 32, and fibrous polymer resin 33 can satisfactorily bind conductive fibers 32 and conductive particles 31, and therefore, gas diffusion layer 3 can have a sufficient strength.

Gas diffusion layer 3 may contain conductive particles 31 of 5 wt % or more and less than 35 wt %. That is, a content of conductive particles 31 may be 5 wt % or more and less than 35 wt % with respect to entire gas diffusion layer 3. When the content of conductive particles 31 is 5 wt % or more, the amount of conductive particles 31 that fills the gap between conductive fibers 32 is sufficient, and therefore, it is hard to increase bulk resistance of gas diffusion layer 3. Further, when the content of conductive particles 31 is less than 35 wt %, the gap between conductive fibers 32 is not reduced too much, the water discharging property or the gas diffusion property is further improved.

Gas diffusion layer 3 may contain conductive fibers 32 of 35 wt % or more and 80 wt % or less. That is, a content of conductive fibers 32 may be 35 wt % or more and 80 wt % or less with respect to entire gas diffusion layer 3. Further, when the content of conductive fibers 32 is 35 wt % or more, the gap between conductive fibers 32 is not reduced too much, the water discharging property or the gas diffusion property is excellent. When the content of conductive fibers 32 is 80 wt % or less, the amount of particles that fills the gap between conductive fibers 32 is sufficient, and therefore, it is hard to increase the bulk resistance of gas diffusion layer 3.

Gas diffusion layer 3 may contain polymer resins 33 of 10 wt % or more and 40 wt % or less. That is, a content of polymer resins 33 may be 10 wt % or more and 40 wt % or less with respect to entire gas diffusion layer 3. When a content of polymer resins 33 is 10 wt % or more, polymer resin 33 sufficiently functions as a binder, and a tensile break strength of gas diffusion layer 3 can be increased. Therefore, even when a gas pressure or expansion and contraction of the electrolyte membrane occurs, gas diffusion layer 3 is hard to break, and durability of the fuel battery using gas diffusion layer 3 is improved. Further, when the content of polymer resins 33 is 40 wt % or less, it is hard to increase the bulk resistance of gas diffusion layer 3, and the battery performance can be improved.

### Pore Volume, Pore Diameter, and Pore Distribution of Gas Diffusion Layer

An occupied volume of the pores in gas diffusion layer 3, that is, the cumulative pore volume of gas diffusion layer 3 may be 1.3 mL/g or more and 1.7 mL/g or less. When the cumulative pore volume is 1.3 mL/g or more, the gas diffusion path and a water discharge path are sufficiently secured, and therefore, deterioration of the battery performance due to flooding is further suppressed. Further, when the cumulative pore volume is 1.7 mL/g or less, the water inside MEA 20 is not excessively discharged to the outside through the pores of gas diffusion layer 3, and the water contained inside MEA 20 is kept better, and therefore, the battery performance can be further improved.

Further, a peak of a pore diameter distribution of gas diffusion layer 3 may be in a range of 0.10 μm or more and 0.30 μm or less. When the peak of the pore diameter distribution is 0.10 μm or more, a size of the pores can be secured, and gas diffusion layer 3 has a sufficient gas permeability and a higher water discharging property. On the other hand, when the peak of the pore diameter distribution is 0.3 μm or less, the water inside MEA 20 is not excessively discharged to the outside through the pores of gas diffusion layer 3, and the water contained inside MEA 20 is kept better, and therefore, the battery performance can be further improved.

The cumulative pore volume and pore distribution of gas diffusion layer 3 can be measured by a mercury intrusion method after drying gas diffusion layer 3 at 120° C. for 4 hours as a pretreatment.

The tensile break strength of gas diffusion layer 3 may be 0.05 N/mm² or more. When the tensile break strength of gas diffusion layer 3 is 0.05 N/mm² or more, it is easy to handle gas diffusion layer 3 as a self-supporting membrane, and gas diffusion layer 3 can have a sufficient strength.

### Method of Manufacturing Gas Diffusion Layer

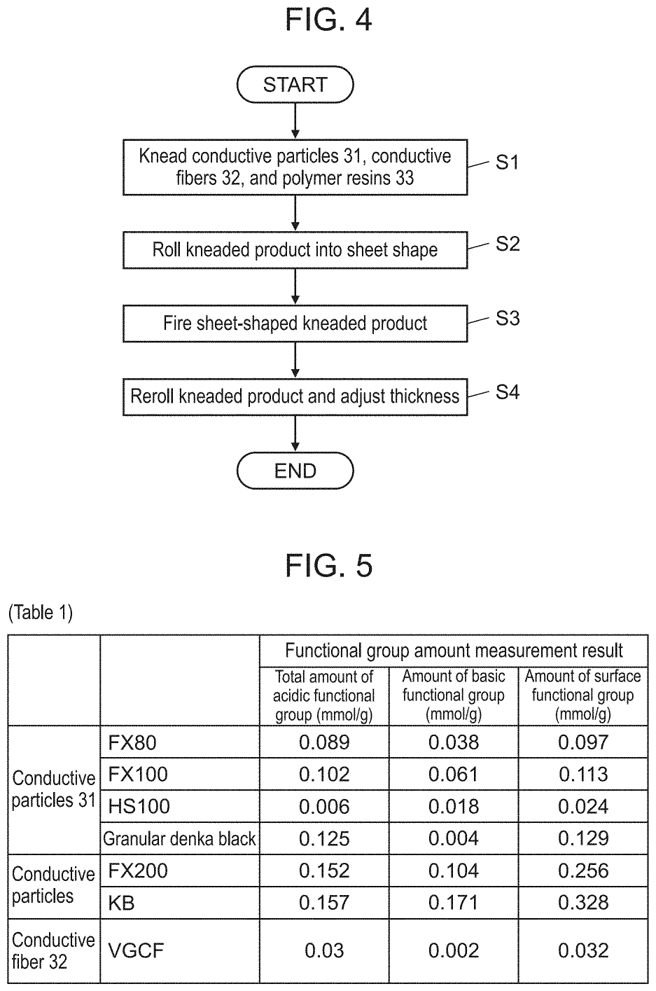

Next, a method of manufacturing gas diffusion layer 3 according to the first exemplary embodiment of the present disclosure will be described. FIG. 4 is a flowchart showing a method of manufacturing gas diffusion layer 3. The method of manufacturing of gas diffusion layer 3 of the present disclosure is not limited to the flowchart of FIG. 4 and a manufacturing method as described below, and may be changed without departing from the gist of the present disclosure.

(a) In Step S1, conductive particles 31, conductive fibers 32, polymer resins 33, a surfactant, and a dispersion solvent are kneaded. First, conductive particles 31 such as carbon materials, conductive fibers 32 such as carbon nanotubes, the surfactant, and the dispersion solvent are mixed, stirred, and kneaded. Thereafter, polymer resins 33 are added to the mixture, and the mixture is stirred and kneaded again to obtain a kneaded product.

In the kneading of the material of Step S1, for example, a planetary mixer, a hybrid mixer, a kneader, a roller mill, or the like can be used. In Step S1, which is a kneading step, conductive particles 31, conductive fibers 32, the surfactant, and the dispersion solvent, excluding polymer resins 33, are first kneaded and dispersed. Thereafter, polymer resins 33 are added to the mixture and stirred, polymer resin 33 can thus be uniformly dispersed in the kneaded product.

(b) In Step S2, the kneaded product is stretched into a sheet shape while rolling. In the rolling of Step S2, for example, a rolling machine can be used. The rolling is performed once or multiple times under a condition of rolling at, for example, 0.001 ton/cm to 4 ton/cm, a shearing force is applied to polymer resins 33 to make it into fibers. By using fibrous polymer resins 33, gas diffusion layer 3 having a high strength can be obtained.

(c) In Step S3, the kneaded product stretched into a sheet shape is fired to remove the surfactant and the dispersion solvent from the kneaded product.

In the firing of Step S3, for example, an IR furnace, a hot air drying furnace, or the like can be used. A firing temperature is set to a temperature higher than a temperature at which the surfactant is decomposed and a temperature lower than a temperature at which polymer resins 33 melt. The reason for this is as follows. When the firing temperature is lower than the temperature at which the surfactant is decomposed, the surfactant remains in gas diffusion layer 3, and water stays due to hydrophilization of inside of gas diffusion layer 3. Therefore, the gas permeability of gas diffusion layer 3 may deteriorate. On the other hand, when the firing temperature is higher than a melting point of polymer resin 33, polymer resins 33 melt, the strength of gas diffusion layer 3 may be thus decreased. Specifically, for example, when PTFE is used as polymer resin 33, the firing temperature may be 280° C. or higher and 340° C. or lower.

(d) In Step S4, the sheet-shaped kneaded product from which the surfactant and the dispersion solvent have been removed is rerolled with a roll press machine to adjust a thickness of gas diffusion layer 3. Thereby, gas diffusion layer 3 according to the first exemplary embodiment of the present disclosure can be manufactured.

In the rerolling of step S4, for example, a roll press machine can be used. The rerolling is performed once or multiple times under a condition of rolling at, for example, 0.01 ton/cm to 4 ton/cm, the thickness and porosity of gas diffusion layer 3 can thus be adjusted.

The present disclosure is not limited to the above exemplary embodiment, and can be implemented in various other aspects.

### EXAMPLES

Hereinafter, Examples of the present disclosure will be described.

### Materials

Materials used for manufacturing test pieces of Examples and Comparative Examples are as follows.

### Conductive Particles

FX-80 (produced by Cabot Corporation)
FX-100 (produced by Cabot Corporation)
FX-200 (produced by Cabot Corporation)
DENKA BLACK HS-100 (produced by Denka Company Limited)
Granular DENKA BLACK (produced by Denka Company Limited)
Ketjen Black (KB) (ECP300, produced by Lion Corporation)

### Conductive Fiber

VGCF (VGCF-H, produced by SHOWA DENKO K.K.)

### Polymer Resin 33

PTFE dispersion (produced by DAIKIN INDUSTRIES, LTD.), average particle diameter of 0.25 μm

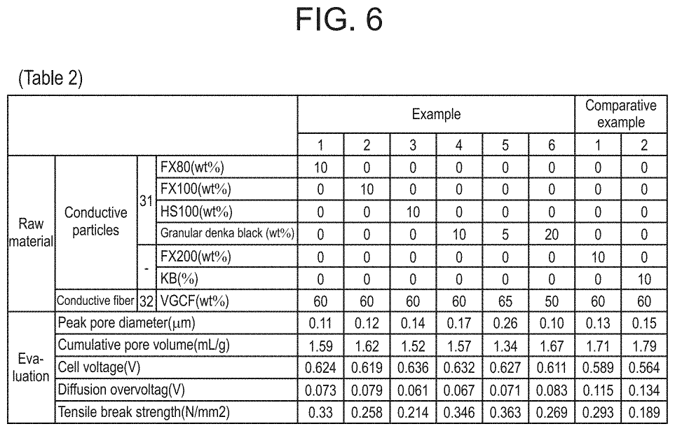

Table 1 in FIG. 5 shows measurement results of an amount of functional groups in a conductive particle and an amount of functional groups in a conductive fiber used as the materials of Examples and Comparative Examples. A method of measuring the amounts of functional groups is as described above. Further, Table 2 in FIG. 6 shows ratios of each raw material and results of an evaluation test performed on Examples 1 to 6 and Comparative Examples 1 and 2.

### Manufacturing of Test Piece

Test pieces of Examples 1 to 6 and Comparative Examples 1 and 2 were manufactured by the following methods.

(a) First, conductive particles, conductive fiber, a surfactant, and a dispersion solvent were mixed in a ratio shown in a raw material column of Table 2, and kneaded using a planetary mixer.

(b) Next, a polymer resin was added to the kneaded mixture in a ratio shown in the raw material column of Table 2, and the mixture was further kneaded using a planetary mixer.

(c) Next, the kneaded product was rolled five times using a rolling machine under a condition of rolling at 0.1 ton/cm. Thereafter, the rolled sheet was placed in an IR furnace and fired at 300° C. for 0.5 hours.

(d) The fired sheet was rerolled three times using a roll press machine under a condition of rolling 1 ton/cm to obtain a gas diffusion layer having a thickness of 100 μm.

The manufactured gas diffusion layer is used as a cathode-side gas diffusion layer, thereby manufacturing a test piece by the following method.

Catalyst-supporting carbon (TEC10E50E produced by Tanaka Kikinzoku Kogyo, 50% by mass of Pt) for supporting platinum particles on carbon powders as an electrode catalyst, and a polymer electrolyte solution (Aquivion D79-20BS produced by Solvay Solexis Inc.) having hydrogen ion conductivity were dispersed in a dispersion solvent in which ethanol and water were mixed (mass ratio of 1:1), thereby preparing a cathode catalyst layer forming ink A polymer electrolyte was added so that a mass of the polymer electrolyte in the catalyst layer after coating formation was 0.4 times a mass of the catalyst-supporting carbon.

The obtained cathode catalyst layer forming ink was applied to one side of a polymer electrolyte membrane (GSII manufactured by Japan Gore-Tex Inc., 120 mm×120 mm) by a spray method to form a cathode catalyst layer so that an amount of the supported platinum was 0.3 mg/cm².

Next, an anode catalyst layer was formed so that the amount of the supported platinum was 0.1 mg/cm², similarly to the cathode catalyst layer.

Carbon paper manufactured by SGL Carbon was used as an anode-side gas diffusion layer.

The gas diffusion layers of Examples 1 to 6 and Comparative Examples 1 and 2 were bonded to the cathode catalyst layer as a cathode-side gas diffusion layer. Further, the anode-side gas diffusion layer was bonded to the anode catalyst layer. As a result, an MEA was obtained.

Next, a fuel battery as a test piece was manufactured using a separator having a flow passage formed therein. First, the manufactured MEA was interposed between an anode-side separator having a fluid flow passage for fuel gas supply and a cooling water flow passage and a cathode-side separator having a gas flow passage for oxidizer gas supply, and a gasket made of a fluororubber is disposed around the cathode and anode, thereby manufacturing a single cell. An area of an effective electrode (anode or cathode) was 36 cm². The single cell was used as a test piece.

### Evaluation Test

The following evaluation test was carried out for Examples 1 to 6 and Comparative Examples 1 and 2. The results are shown in Table 2 of FIG. 6.

### Cumulative Pore Volume

The cumulative pore volume was measured by a mercury intrusion method using the gas diffusion layers of Examples 1 to 6 and Comparative Examples 1 and 2 manufactured by the above method. For the measurement, AutoPore IV 9520 manufactured by Micromeritics Instrument Corp. was used. First, the gas diffusion layer was dried at a constant temperature of 120° C. for 4 hours, and then the pore distribution having a pore radius of about 0.0018 μm to 100 μm was measured. Based on the pore distribution, the cumulative pore volume was calculated from the following Washburn equation. PD=−4σ cos θP is a pressure, D is a pore diameter, σ is a surface tension of mercury, and θ is a contact angle between mercury and the sample. The surface tension of mercury was calculated as 480 dynes/cm, and the contact angle between mercury and the sample was calculated as 140°.

### Peak Pore Diameter

From the graph of the pore distribution showing a mercury intrusion amount for each pore diameter obtained when calculating the cumulative pore volume described above, the pore diameter having the largest mercury intrusion amount was defined as a peak pore diameter.

### Tensile Break Strength

Tensile break strengths of the gas diffusion layers of Examples 1 to 6 and Comparative Examples 1 and 2 manufactured by the above method were measured by punching a dumbbell test piece (No. 4 dumbbell) defined in JIS K 6251 with the Thomson die, using a tensile and compression testing machine (SVZ-200NB model, manufactured by IMADA SEISAKUSHO CO., LTD.).

### Cell Voltage

The cell voltage was measured under the following conditions. A cell temperature of a single cell of the test piece was controlled to 75° C., a hydrogen gas as a fuel gas was supplied to the gas flow passage on the anode side, and air was supplied to the gas flow passage on the cathode side. Hydrogen gas stoichiometry was 1.5 and air stoichiometry was 1.8. Both the hydrogen gas and the air were humidified so that dew points thereof were 75° C., and then supplied to the single cell. The cell voltage was held for three minutes every 0.5 A/cm² of the current density from 0 A/cm² to 2.0 A/cm², thereby measuring the cell voltage when it is 2.0 A/cm².

### Diffusion Overvoltage

A diffusion overvoltage was measured when it is 2.0 A/cm² under the same condition as the above cell voltage measurement.

### Resistance Overvoltage

A resistance overvoltage was measured when it is 2.0 A/cm² under the same condition as the above cell voltage measurement.

As shown in Table 2 of FIG. 6, in the gas diffusion layers of Examples 1 to 6, a gas diffusion layer having the amount of surface functional groups in conductive particle 31 of 0.25 mmol/g or less, the total amount of acidic functional groups in conductive particle 31 of 0.15 mmol/g or less, and the amount of basic functional groups in conductive particle 31 of 0.10 mmol/g or less is used. Therefore, in Examples 1 to 6, the cell voltage is high and the diffusion overvoltage is low as compared with Comparative Examples 1 and 2. Therefore, in Examples 1 to 6, the excess water on the cathode side is less likely to stay inside the gas diffusion layer on the cathode side at a high current density, such that it could be confirmed that the gas diffusion property is improved and the diffusion overvoltage is lowered to 2.0 A/cm², and as a result, the cell voltage is also increased.

Further, KB used in Comparative Example 2 has a low resistance of the conductive particle itself than a resistance of DENKA BLACK used in Example 4, and an electronic resistance of the gas diffusion layer alone in Comparative Example 2 is easily lowered as compared with Example 4. However, when power is generated as a battery, in Example 4, since the water inside of the battery can be kept in a good condition, proton resistance is reduced as compared with Comparative Example 2, and as a result, the resistance overvoltage is maintained at the same level as in Comparative Example 2.

It should be noted that the present disclosure includes an appropriate combination of any exemplary embodiments and/or Examples of various exemplary embodiments and/or Examples described above, the effects of the respective exemplary embodiments and/or Examples can be achieved.

The gas diffusion layer of the present disclosure is particularly useful as a member used for the fuel battery, and can be applied to applications such as a home cogeneration system, a vehicle fuel battery, a mobile fuel battery, and backup fuel battery.

What is claimed is:

1. A gas diffusion layer comprising:
conductive particles;
conductive fibers; and
polymer resins,
wherein an amount of surface functional groups in each of the conductive particles is 0.25 mmol/g or less.

2. A gas diffusion layer comprising:
conductive particles;
conductive fibers; and
polymer resins,
wherein a total amount of acidic functional groups in each of the conductive particles is 0.15 mmol/g or less.

3. A gas diffusion layer comprising:
conductive particles;
conductive fibers; and
polymer resins,
wherein an amount of basic functional groups in each of the conductive particles is 0.10 mmol/g or less.

4. The gas diffusion layer of claim 1,
wherein an amount of surface functional groups in each of the conductive fibers is 0.3 mmol/g or less.

5. The gas diffusion layer of claim 1,
wherein a total amount of acidic functional groups in each of the conductive fibers is 0.15 mmol/g or less.

6. The gas diffusion layer of claim 1,
wherein an amount of basic functional groups in each of the conductive fibers is 0.10 mmol/g or less.

7. The gas diffusion layer of claim 1,
wherein an amount of the conductive fibers in the gas diffusion layer is larger than an amount of the conductive particles in the gas diffusion layer.

8. The gas diffusion layer of claim 1,
wherein each of the conductive particles includes carbon black having a BET specific surface area of 100 m²/g or less.

9. The gas diffusion layer of claim 1,
wherein each of the conductive fibers includes a carbon nanotube having a fiber diameter of 50 nm or more and 300 nm or less and a fiber length of 0.5 μm or more and 50 μm or less.

10. The gas diffusion layer of claim 1,
wherein each of the polymer resins includes polytetrafluoroethylene.

11. The gas diffusion layer of claim 1,
wherein the gas diffusion layer includes the conductive particles of 5 wt % or more and less than 35 wt %.

12. The gas diffusion layer of claim 1,
wherein the gas diffusion layer includes the conductive fibers of 35 wt % or more and 80 wt % or less.

13. The gas diffusion layer of claim 1,
wherein the gas diffusion layer includes the polymer resins of 10 wt % or more and 40 wt % or less.

14. The gas diffusion layer of claim 1,
wherein the conductive particles, the conductive fibers, and the polymer resins constitute a porous structure,
a cumulative pore volume of the porous structure is 1.3 mL/g or more and 1.7 mL/g or less, and
a peak of a pore diameter distribution of the porous structure is in a range of 0.1 μm or more and 0.3 μm or less.

15. The gas diffusion layer of claim 1,
wherein a tensile break strength of the gas diffusion layer is 0.05 N/mm² or more.

16. The gas diffusion layer of claim 1,
wherein the gas diffusion layer is a self-supporting membrane supported by the conductive particles, the conductive fibers, and the polymer resins.

17. A membrane electrode assembly comprising:
the gas diffusion layer of claim 1;
a pair of electrodes; and
an electrolyte membrane.

18. A fuel battery comprising:
the gas diffusion layer of claim 1; and
a current collecting plate.
